(19) United States
(12) Patent Application Publication
(10) Pub. No.: US 2013/0259446 A1
(43) Pub. Date: Oct. 3, 2013

(54) METHOD AND APPARATUS FOR USER DIRECTED VIDEO EDITING

(71) Applicant: Sailesh Kumar Sathish, Tampere (FI)

(72) Inventor: Sailesh Kumar Sathish, Tampere (FI)

(73) Assignee: Nokia Corporation, Espoo (FI)

(21) Appl. No.: 13/432,694

(22) Filed: Mar. 28, 2012

(51) Int. Cl. H04N 5/93

(52) U.S. Cl. 386/278; 386/E05.003

(57) ABSTRACT

An approach is provided for user directed video editing. A media platform determines one or more viewpoints of a live event selected by a user. The media platform then determines respective media segments that depict the respective one or more viewpoints. The media segments include metadata of orientation information, geo-location information, timing information, or a combination thereof associated with the creation of respective media segments. The media platform then determines to generate a compilation of at least a portion of the media segments based, at least in part, on the metadata.

### BACKGROUND

Service providers and device manufacturers (e.g., wireless, cellular, etc.) are continually challenged to deliver value and convenience to consumers by, for example, providing compelling network services. The amount of user-created content accessible by devices through the network services is increasing. However, no services currently exist that allow a user to view and edit live event media (e.g., an image or a video) captured by onsite devices (either by the commercial photographers or end users) based on the characteristics associated with the media, such as an object or a location associated with the media, object characteristics associated with the media, or media characteristics. Therefore, service providers and device manufacturers face significant technical challenges in providing a service that allows users to view and edit live event media based on, for example, user preferences, the location of the media, as well as other characteristics associated with the media.

### SOME EXAMPLE EMBODIMENTS

Therefore, there is a need for an approach for user directed video editing.

According to one embodiment, a method comprises determining one or more viewpoints of a live event selected by a user. The method also comprises determining respective media segments that depict the respective one or more viewpoints, wherein the media segments include metadata of orientation information, geo-location information, timing information, or a combination thereof associated with the creation of respective media segments. The method further comprises determining to generate a compilation of at least a portion of the media segments based, at least in part, on the metadata.

According to another embodiment, an apparatus comprises at least one processor, and at least one memory including computer program code for one or more computer programs, the at least one memory and the computer program code configured to, with the at least one processor, cause, at least in part, the apparatus to determine respective media segments that depict the respective one or more viewpoints. The apparatus is also caused to determine one or more viewpoints of a live event selected by a user, wherein the media segments include metadata of orientation information, geo-location information, timing information, or a combination thereof associated with the creation of respective media segments. The apparatus is further caused to determine to generate a compilation of at least a portion of the media segments based, at least in part, on the metadata.

According to another embodiment, a computer-readable storage medium carries one or more sequences of one or more instructions which, when executed by one or more processors, cause, at least in part, an apparatus to determine respective media segments that depict the respective one or more viewpoints. The apparatus is also caused to determine one or more viewpoints of a live event selected by a user, wherein the media segments include metadata of orientation information, geo-location information, timing information, or a combination thereof associated with the creation of respective media segments. The apparatus is further caused to determine to generate a compilation of at least a portion of the media segments based, at least in part, on the metadata.

According to another embodiment, an apparatus comprises means for determining one or more viewpoints of a live event selected by a user. The apparatus also comprises means for determining respective media segments that depict the respective one or more viewpoints, wherein the media segments include metadata of orientation information, geo-location information, timing information, or a combination thereof associated with the creation of respective media segments. The apparatus further comprises means for determining to generate a compilation of at least a portion of the media segments based, at least in part, on the metadata.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of supporting user directed video editing, according to one example embodiment;

FIGS. 2A and 2B are diagrams of the components of a media platform and a user interface client, respectively, according to one example embodiment;

FIG. 3 is a flowchart of a process for user directed video editing, according to one example embodiment;

FIGS. 4A-4C are diagrams of a user interface utilized in the process of FIG. 3, according to various example embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for user directed video editing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, structures and devices are shown in block diagram form in order to avoid unnecessarily obscuring the embodiments of the invention.

As used herein, the term “media” refers to any type of media that may include, for example, one or more images, one or more fragments or portions of images, one or more animated images, one or more fragments or portions of animated images, one or more videos, one or more fragments or portions of videos, or a combination thereof, where the media may be two-dimensional, three-dimensional, or a combination thereof. Although various embodiments are described with respect to images and videos, it is contemplated that the approach described herein may be used with other type of content that can be indexed according to one or more characteristics associated with the media.

Although various embodiments are described with respect to a remote user, it is contemplated that the approach described herein may be used by onsite users of the service and service providers.

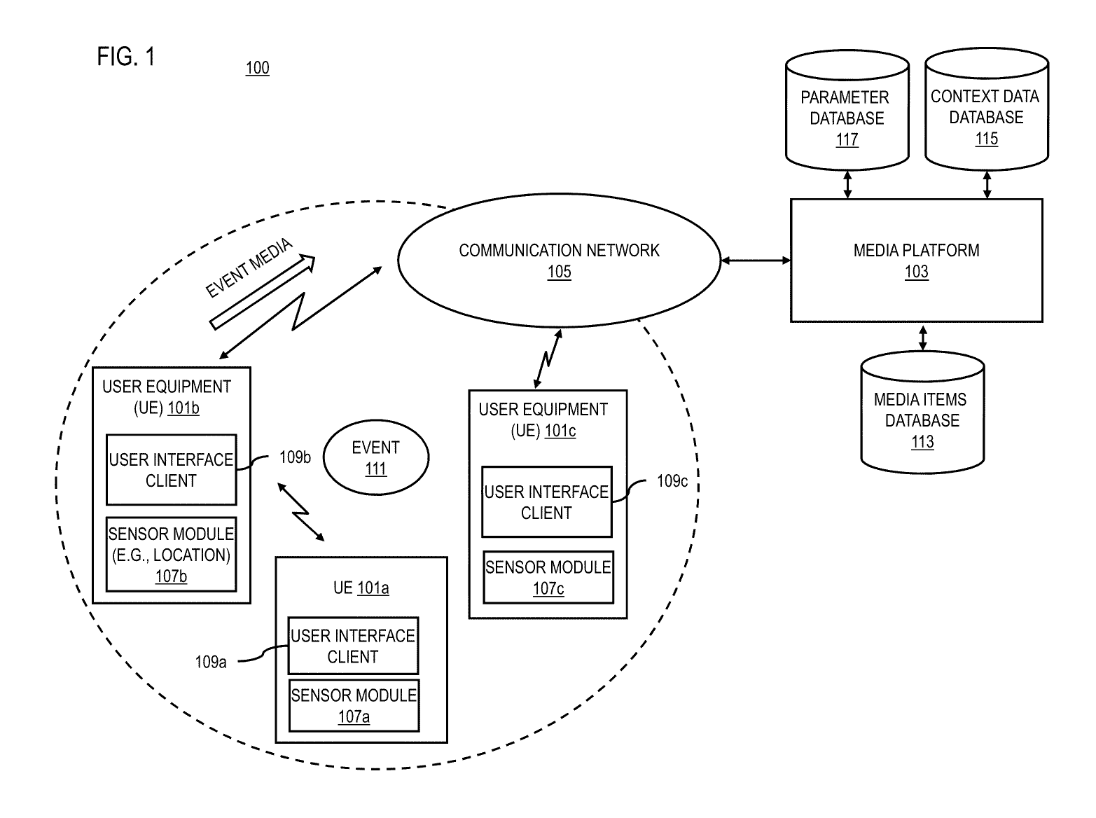

FIG. 1 is a diagram of a system capable of supporting user directed video editing, according to one example embodiment of the invention. As discussed above, the popularity of user-created media has exponentially increased the amount of media that is accessible through various service providers and the Internet. More users now share event media files (e.g., video, audio, images, etc.) with others using one or more social network services platforms (e.g., FACEBOOK®, YOUTUBE®, LINKEDIN®, MEETUP®, BLOGGER®, etc.). Examples of events include sports competitions, concerts, cultural events, product releases, fashion shows, trade shows, conventions, festivals, parties, ceremonies, disasters, and the like. Many events are recorded by more than one user using one or more personal recording devices (e.g., a mobile phone, a camcorder, a digital camera, etc.) from different viewpoints. Users may wish to view the media of live events from different viewpoints. The users may also wish to edit the different views of the live events into a personalized or director's cut (DC). “Cut” refers to the process of media editing. A director's cut is a specially edited version of a film, TV series, music video, commercials, comic book or video games, as edited by the director. However, the developments associated with video sharing platforms have not supported such live event viewing and editing.

To address this problem, a system 100 of FIG. 1 introduces the capability to support remote user directed video editing. According to one example embodiment, the system 100 identifies an event location of onsite user devices connected to the system, and the system 100 checks whether there is a map present for the event. If so, the system 100 downloads the map to the client software of the onsite and remote user devices. The system 100 manages live feeds including storage, resolutions of content and metadata. For onsite users, the map may be used for location resolutions and for recommending the users to move across the venue if required. For the remote user, the system 100 records target and source information for a video feed. When there is a significant change in orientation or location information of the viewpoint specified by the remote user, the system 100 recomputes target and source positions. The system 100 maintains and manages the feed so as to provide the most optimal feeds taking into account aspects such as quality of feeds, bandwidth requirements, resource requirements, etc.

The system 100 determines a plurality of media items (e.g., videos) taken by a plurality of users throughout the course of at least one live event (e.g., a concert) using one or more personal recording devices and uploaded by the users to one or more services that are capable of processing and buffering the plurality of media items. By way of example, an event (e.g., a concert) may have a center stage (Side “A”), a left stage (Side “B”), and a right stage (Side “C”) and/or the users may have a front view of the stage, a left view of the stage, and a right view of the stage based on the orientations of the users. In this instance, the remote user selects a plurality of potential viewpoints associated with a violinist, a singer, etc. The viewpoints or focuses could also reference one or more ordinal directions (e.g., left, right, up, down, front, back, etc.). In one example embodiment, the system 100 can utilize a focus point analysis to determine additional viewpoints or sub-events within an event, wherein additional media segments may be determined based on the focuses.

In one example, throughout the course of an event (e.g., a concert) users will capture a plurality of media items (e.g., a video) of the event. Because Side “A” represents the center stage, many of the media items of the event will have been focused on Side “A” of the event. However, the same and/or different users will also likely capture media of the event relating to Sides “B” and “C” as well. The system 100 then determines context data (e.g., metadata) associated with the uploaded media to segment the plurality of media items into one or more media segments based on the respective viewpoints or areas of interest of the event (e.g., a violinist, a singer, etc.”). By way of example, the context data can be generated by one or more sensors built-in to the personal recording devices used by the users to capture the video of the event (e.g., an orientation sensor, an accelerometer, a timing sensor, a global position system (GPS), an electronic compass, etc.).

The system 100 may render a user interface for determining a selection of at least one source-target pair by a remote user as a viewpoint for streaming one or more media segments of interest. By way of example, the system 100 may render a user interface in the form of a map on a user device. The map may cover an area that is selected by a user, such as a specific stage, specific coordinates, a boundary around a specific location, or the like. Thus, based on the user interface of the map, the user may query for media segments that is associated with the viewpoint marked in the map.

By way of example, if the user is querying for media segments associated with a violinist viewing from the left front section of the concert hall, the remote user may touch the user interface to indicate a source position S, and draw a line toward a target position T to provide a viewpoint of interest that would result in selecting the appropriate direction and distance of one or more user devices on a server end as a basis for performing a match/selection media segments process. Alternatively, the user may touch two points on the user interface wherein the first point of touch indicates the source and the second point of touch indicates the target, or vice versa, depending on the system, the event, the stage type, etc. By way of example, when the first point of touch corresponds to an audience seat and the second point of touch corresponds with a spot on the stage, the system assumes the first point of touch as the source and the second point of touch as the target. Each onsite device can take a plurality of media items at different directions, angles, zooms, etc., to generate a plurality of media segments.

In another embodiment, the user enters a plurality of source-target pairs in sequence with various time periods in-between for media segments associated with a camera movement flow in the concert hall. The system 100 matches/selects media segments accordingly to compile a customized cut for the user.

Alternatively, or in addition to the foregoing, the user may select an object of interest, such as the violinist, as a basis for performing a media segment match/selection process. Further, the user may enter characteristics associated with an object, such as any performer moving on the stage, and may further select one or more characteristics associated with the media segments/items, such as sudden changes of sound/lighting volumes (e.g., climax of the music, audience clapping, etc.), time of day, season, orientation, depth of field, white balance, author(s), etc. In another embodiment, the system 100 suggests an object of interest, characteristics associated with an object, characteristics associated with the media segments/items, or a combination thereof for the user to select. By way of example, the system 100 retrieves a concert attendee list, analyzes the list for the social connections between the user and the concert attendees, generates user group options, such as FACEBOOK® contacts, for the user to select, and then retrieves media items captured by the selected user group to generate personalized videos.

By way of example, the system 100 selects media segments based upon one or more characteristics associated with the media segment/item authors, such as members of a symphony orchestra fan club, concert hall volunteers, friends of the remote users at FACEBOOK®, jazz festival attendees, etc.

The system 100 further renders one or more results of the query in the user interface. The one or more results of the query represent the media segments that are associated with the selected source-target pairs, objects, and/or characteristics. For example, where the user interface is associated with a map of a concert hall, the results of the query are media segments that are associated with the location.

The context data is used by the system 100 to determine the viewpoints of the users (i.e., the one or more directions the users were pointing their recording devices during the event) and to determine at least one focus for the event (e.g., the signer danced on the side “C”) for matching media segments.

In one example embodiment, the system 100 determines the focus by analyzing the plurality of media items to determine the region or viewpoint of the event a majority of the users focused on with their recording devices (e.g., the signer danced on the side “C”). In another example embodiment, the system 100 may determine the focus by analyzing the areas of visual or audio overlap among the plurality of recorded media. In one embodiment, the system 100 utilizes the focus as a viewpoint to match/select media segments based on referring to the violinist, the singer, etc. In one example, the system 100 also performs a quality analysis of the one or more media segments by using, for example, accelerometer information for shake detection and image quality determinations, audio analysis for audio quality determinations, and so forth. The system 100 can also further qualify the one or more media segments based on these quality parameters.

In one embodiment, if the user is creating a video that involves different events at the same or different locations with many different objects associated with the events, the system 100 may provide the user a way of querying for media segments based on the events and/or objects associated with the events according to the characteristics associated with the media segments. By way of example, a friend of the bride, who cannot attend the wedding but wants to make a customized video of a wedding reception and a wedding in a church of the bride, directs the video by querying the system 100 for live media segments generated by the user devices onsite. Concurrently or later, the friend can share the video on social network platforms with the onsite guests, other friends who cannot attend the wedding, and/or other people (news media, fan clubs, etc.).

In another embodiment, the system 100 can operate in a collaboration mode to support multiple users' queries for editing the same video. Continuing with the wedding example, the bride's friend may collaborate with any number of onsite or offsite individuals (even the bride) to select source-target pairs, objects, and/or characteristics for matching media segments. The system 100 may apply polling and locking mechanisms to resolve conflicts in the collaboration. By way of example, the system 100 prioritizes the users to implement their selections accordingly.

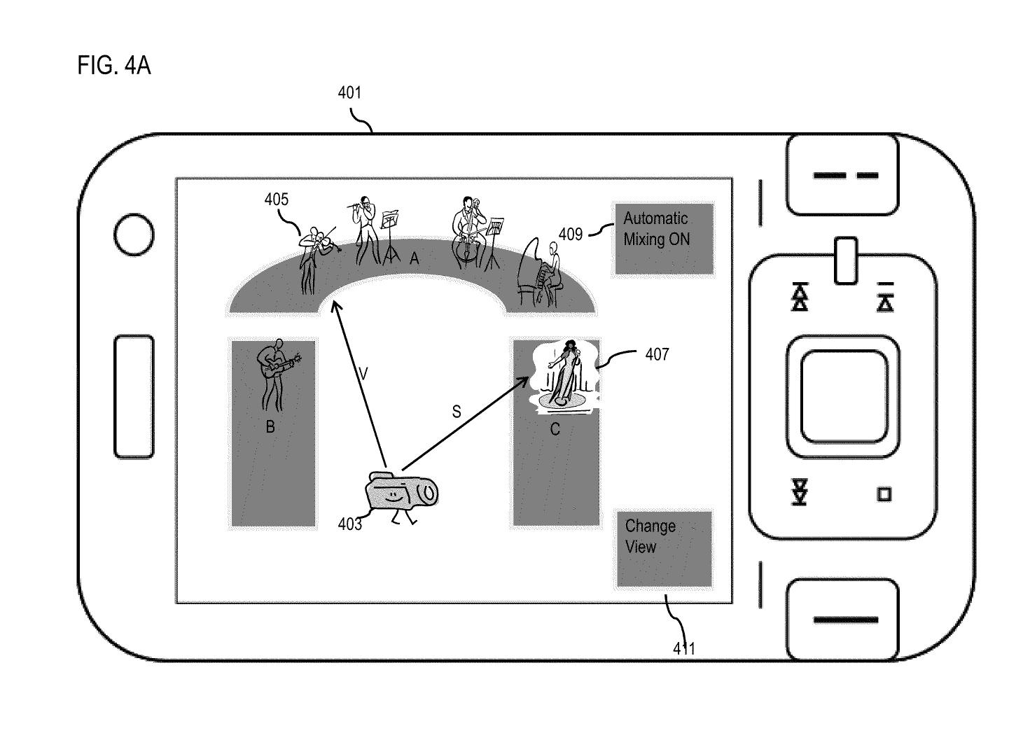

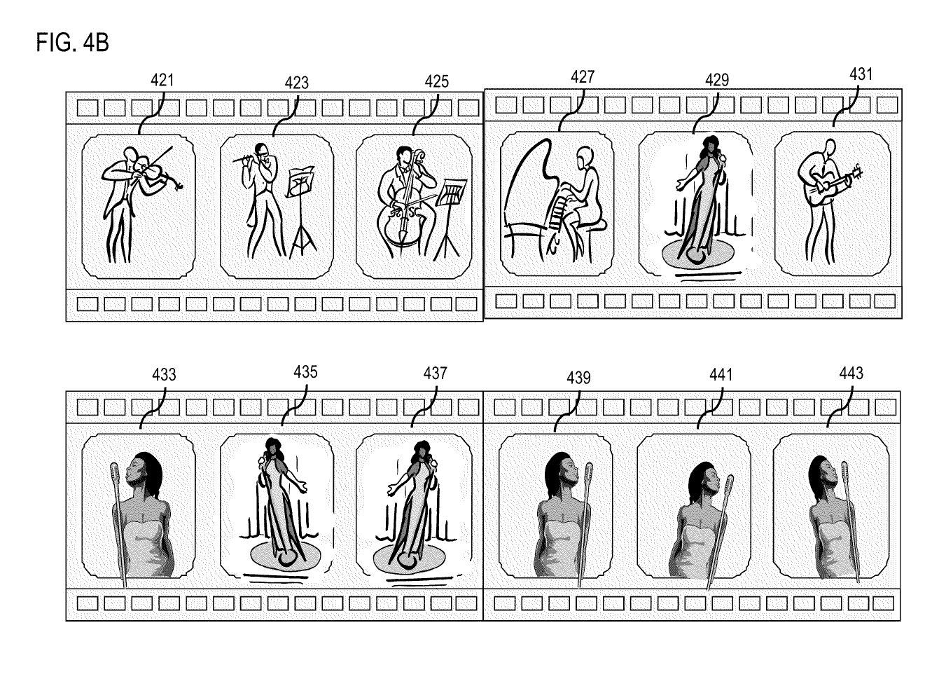

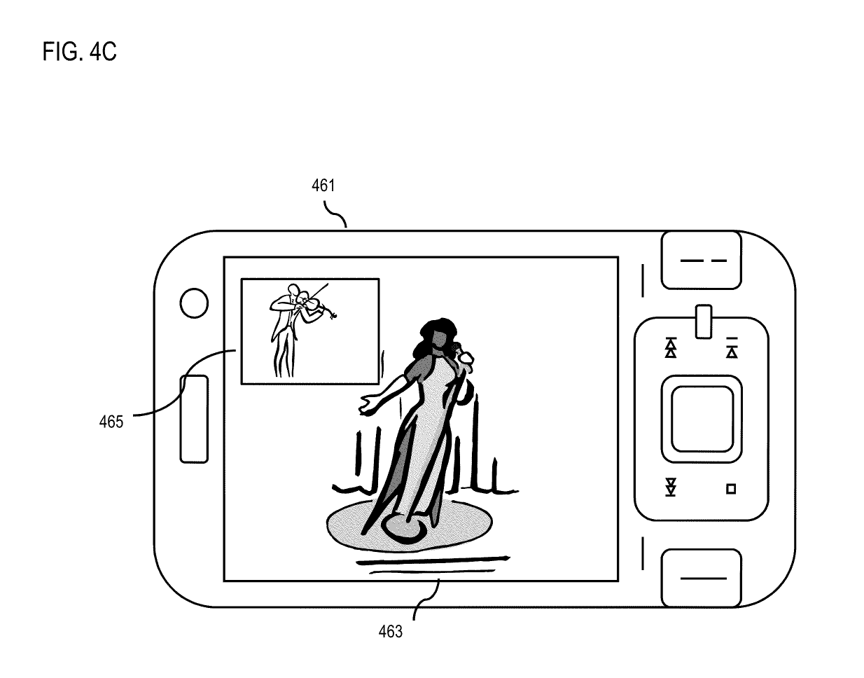

In another embodiment, the user concurrently creates two or more videos that involve the same or different events at the same or different locations with many different objects associated therewith. The videos can be rendered concurrently on different user devices, or split screens on the same device, or picture-in-picture on the same device, etc. An illustrative example of a two-dimensional user interface is shown in FIGS. 4A and 4C.

In one example embodiment, the system 100 causes a synchronization of the matched media segments and then generates a customized media item (e.g., a personalized video/cut) based, at least in part, on the synchronization of the media segments. The system 100 can generate the customized media item based on different synchronization criteria among the media segments. When there are two or more personalized videos generated concurrently, they may have different synchronization criteria; however, in most cases, the videos begin and end at the same time. By way of example, in one concert hall, the videos representing the singer, and the symphony orchestra may all start at the same time, but the singer may finish before the symphony orchestra. In one embodiment, the system 100 can synchronize the plurality of videos based on the same set of parameters that the system 100 used to synchronize the one or more media segments within the videos. By way of example, the system 100 can determine to synchronize the videos based on timing information, sensor information, media quality information, one or more audio cues, one or more visual cues, or a combination thereof associated with the plurality of the media items, the one or more media segments, the at least one event, or a combination thereof. As a result, the system 100 can render each media video of the concert separately on respective display screens.

In one example embodiment, when the system 100 determines to present the customized media items/segments and/or user interface (UI) on a three-dimensional display, the system 100 causes a rendering of a user interface that can include one or more objects with facets associated with the respective one or more user interface elements, one or more videos, or a combination thereof. By way example, the system 100 can determine to render a user interface consisting of a cube for a customized media item consisting of six viewpoints, or an object determined by a user based on the same concept of associating a facet of the object with a viewpoint and/or personalized video. In this example, a user can use a gesture on the facet of the cube interface to cause the system 100 to rotate the UI and/or select one or more corresponding viewpoints or personalized videos to present and/or playback. In another example, a user can use a split gesture to cause the system 100 to divide two or more personalized videos of the UI (e.g., a cube) to create two more presentations on the same screen. Further, a select and combinational gesture by a user can cause the system 100 to combine two or more personalized videos in different manners.

As shown in FIG. 1, the system 100 comprises one or more user equipment (UEs) 101a-101c (also collectively referred to as the UEs 101) containing a user interface client 109a-109c (also collectively referred to as user interface client 109) having connectivity to a media platform 103 via a communication network 105. In one example embodiment, the UEs 101 are used to capture media items/files (e.g., videos, photos, audio, etc.) at an event 111 (e.g., a concert) and then transmit the plurality of media items taken by different user devices and related information (e.g., context data and/or metadata) to the media platform 103 for further processing and/or storage in the media items database 113 and the context data database 115, respectively. In one embodiment, the user interface client 109 of the UEs 101 and media platform 103 interact according to a client-server model to present and/or playback a customized media item (e.g., a personalized video). In one embodiment, the UEs 101 may include a sensor module 107a-107c (also collectively referred to as sensor modules 107) to determine context data associated with the plurality of media items (e.g., location information, timing information, orientation, etc.). The sensor modules 107 may be utilized by one or more applications (not shown for illustrative purposes) to capture media of an event 111. In one embodiment, the user interface client 109 renders the user interface of the UEs 101 based on the videos and orientation information associated with the plurality of channels determined from the sensor modules 107. In addition, the user interface client 109 renders the user interface of the UEs 101 based on the ability to use the UEs to multiplex the videos. If the UEs 101 include a three-dimensional display screen, the user interface client 109 can also render the user interface of the UEs 101 as an object (e.g., a cube) having facets associated with the respective one or more user interface elements. In one embodiment, the system 100 has been simplified to include three UEs 101 (e.g., UE 101a-101c) to record and/or capture media items/files on the event 111, however, it is contemplated that any number of UEs 101 can be utilized in capturing information about the event 111. By way of example, a single UE 101 may also be used to capture a portion of an event (e.g., a violinist) and then later that same UE 101 may be used to capture a portion of the same event (e.g., a singer) or even a different event. The media platform 103 can then determine to generate two videos corresponding to the viewpoints, respectively.

In one example embodiment, when the plurality of media items is captured by the UEs 101, related context data (e.g., metadata) is also simultaneously generated for example from the sensor modules 107 within the UEs 101 and the context data can then be determined and associated with the plurality of media items by the media platform 103 or by the UEs 101 themselves. By way of example, the context data associated with the plurality of media items can include time information, a position of the UEs 101, an altitude of the UEs 101, a tilt of the UEs 101, an orientation/angle of the UEs 101, a zoom level of the camera lens of the UEs 101, a focal length of the camera lens of the UEs 101, a field of view of the camera lens of the UEs 101, a radius of interest of the UEs 101 while capturing the media content, a range of interest of the UEs 101 while capturing the media content, or a combination thereof. The position of the UEs 101 can be also be detected from one or more sensors of the UE 101 (e.g., via GPS). The user's location can be determined by Cell of Origin, wireless local area network triangulation, or other location extrapolation technologies. Further, the altitude can be detected from one or more sensors such as an altimeter and/or GPS. The tilt of the UEs 101 can be based on a reference point (e.g., a camera sensor location) with respect to the ground based on accelerometer information. Moreover, the orientation can be based on compass (e.g., magnetometer) information and may be based on a reference to north. One or more zoom levels, a focal length, and a field of view can be determined according to a camera sensor. Further, the radius of interest and/or focus can be determined based on one or more of the other parameters contained in parameter database 117 or another sensor (e.g., a range detection sensor).

In one embodiment, the media platform 103 may receive the plurality of media items (e.g., videos) and context data associated with the media items from the UEs 101 and then buffer the information in the media items database 113 and the context data database 115, respectively. Alternatively, the context data can be buffered as a part of the respective media items. The media items database 113 can be utilized for collecting and buffering the plurality of media items. More specifically, the media items database 113 may include a plurality of media items (e.g., videos), one or more media segments (e.g., video referring to the violinist, and/or the singer), one or more customized media items (e.g., personalized video), or a combination thereof. Further, the context data database 115 may be utilized to store current and historical data about one or more events, and which media items belong to which event, media channels and/or customized media items. Moreover, the media platform 103 may have access to additional historical data (e.g., historical sensor data or additional historical information about a region that may or may not be associated with events) to determine if an event is occurring or has occurred at a particular time. This feature can be useful in determining if newly uploaded media items can be associated with one or more events. In one embodiment, the media platform 103 also determines one or more parameters associated with editing, synchronizing, presenting, or a combination thereof from the one or more parameters stored in the parameter database 117. More specifically, the media platform 103, in connection with the user interface client 109, can utilize the one or more parameters stored in the parameter database 117 to generate or more customized media items (e.g., a personalized video). The media items database 113, the context data database 115, and/or the parameter database 117 may exist in whole or part within the media platform 103, or independently.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), Near Field Communication (NFC) network, and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, mobile communication device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

By way of example, the UEs 101 and the media platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the user interface client 109 of the UEs 101 and the media platform 103 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to multiple processes on multiple hosts (sometimes called tiers) for reasons that include reliability, scalability, and redundancy, among others.

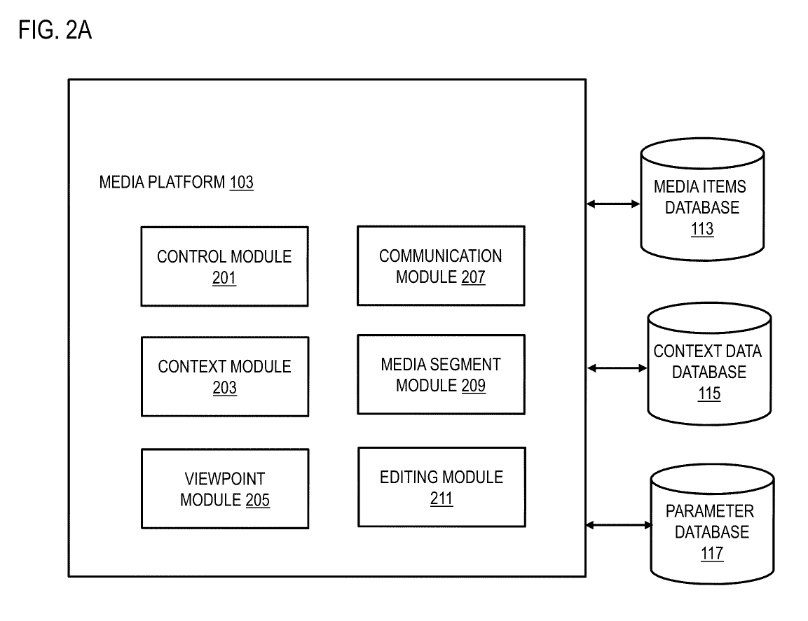

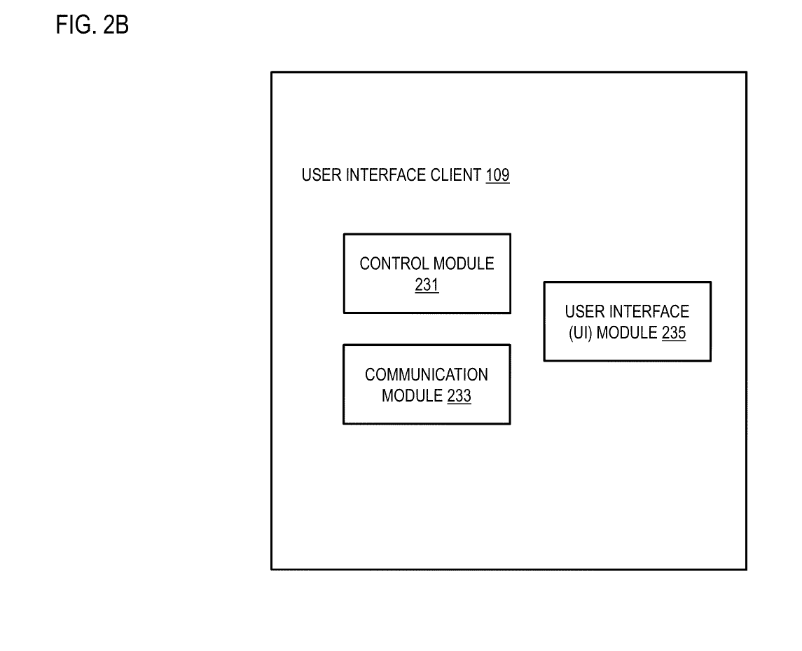

FIG. 2A is a diagram of the components of a media platform 103, according to one example embodiment of the invention. By way of example, the media platform 103 includes one or more server side components for providing generation of personalized video. It is contemplated that the functions of these components may be combined in one or more components or performed by other components of equivalent functionality. In this embodiment, the media platform 103 includes a control module 201, a context module 203, a viewpoint module 205, a communication module 207, a media segment module 209, and an editing module 211.

The control module 201 executes at least one algorithm for executing functions of the media platform 103. For example, the control module 201 may execute an algorithm for processing a request from a UE 101 (e.g., a mobile phone) to upload a plurality of media items (e.g., videos) captured at an event (e.g., a concert) by the UE 101. By way of another example, the control module 201 may execute an algorithm to interact with the context module 203 to determine the context or situation of the UEs 101 and/or the plurality of media items captured by the UEs 101 (e.g., location, orientation, timing, etc.). The control module 201 also may execute an algorithm to interact with the viewpoint module 205 to cause a determination of one or more view points as indicated (e.g., via typing, touching a screen, etc.) by a remote user. The control module 201 may also execute an algorithm to interact with the communication module 207 to communicate among the media platform 103, the UEs 101 including the sensor modules 107 and the one or more applications (not shown for illustrative purposes), the media items database 113, the context data database 115, and the parameter database 117. The control module 201 also may execute an algorithm to interact with the media segment module 209 to cause a segmentation of the plurality of media items into one or more media segments based on a plurality of viewpoints (e.g., a violinist, a singer. Etc.), to match/select media segments based upon other user indicated criteria (e.g., timing, object characteristics, media segment/item characteristics, etc.). The control module 201 also may execute an algorithm to interact with the media segment module 209 and the editing module 211 to generate videos for respective one or more plurality of viewpoints. The control module 201 may also execute an algorithm to interact with the editing module 211 to synchronize the one or more media segments and/or the videos, and edit the one or more media segments within the videos. The control module 201 also may execute an algorithm to interact with the user interface client 109 to cause the user interface client 109 to render a user interface for presenting the customized media item (e.g., a personalized video) on a device based on the viewpoints with two-dimensional and/or three-dimensional display capabilities (e.g., a mobile device, a pico projector, or a combination thereof).

In one embodiment, the context module 203 may determine context data (e.g., metadata) from built-in sensors associated with the personal recording devices (e.g., a mobile phone, a camcorder, a digital camera, etc.) used by one or more users to capture the plurality of media items (e.g., videos) of an event (e.g., a concert) and then uploaded to one or more databases. By way of example, the context data can be generated by one or more sensors built-in to the personal recording devices (e.g., an orientation sensor, an accelerometer, a timing sensor, GPS, etc.). More specifically, the context data associated with the media can include information related to the capture of the plurality of media items such as time, position, altitude, tilt, orientation, zoom, focal length, field of view, radius of interest, range of interest, or a combination thereof. The context module 203, in connection with the editing module 211, may be used to determine an object of interest (e.g., a violinist) for an event (e.g., a concert) as well as a plurality of viewpoints (e.g., from the left front section, etc.) using one or more source-target pairs. In one embodiment, the context module 203 may also be used to determine the plurality of predetermined or default viewpoints based on one or more ordinal directions from a central viewpoint (e.g., left, right, up, down, front, back, or a combination thereof). The context module 203, in connection with the communication module 207, may communicate the number and orientation of the viewpoints to the user interface client 109. In one example embodiment, context module 203, in connection with the editing module 211, can utilize a focus point analysis to determine the viewpoints or focuses, wherein additional viewpoints are determined based on the focuses, such as the climax of the music, performer's movement, etc. Further, the context module 203, in connection with the media segment module 209 and editing module 211, may be used to generate a videos based on the viewpoints determined for an event (e.g., a violinist, a singer, etc.), synchronize one or more media segments and/or a videos, and/or edit the one or more media segments for each video.

In one embodiment, the viewpoint module 205 causes a segmentation of the plurality of media items uploaded and buffered in one or more databases into one or more media segments based on which viewpoint of an event a particular media item refers to (e.g., a violinist, a singer, etc.). By way of example, a media item can refer to a particular viewpoint of the event when an onsite user directs his or her recording device (e.g., a mobile phone) in that direction (e.g., towards the violinist).

The communication module 207 is used for communication between the media platform 103, the sensor modules 107, the one or more applications, the media items database 113, the context data database 115, and the parameter database 117. The communication module 207 may be used to communicate commands, requests, data, etc. By way of example, the communication module 207 may be used to transmit a plurality of media items captured by a mobile device (e.g., a mobile camera) at an event (e.g., a concert) and the context data associated with the media items to the media items database 113 and the context data database 115, respectively. In one embodiment, the communication module 207 is used to transmit the plurality of media items and associated context data from the one or more databases to the context module 203 and viewpoint module 205 in order to begin the process of segmenting the plurality of media items into one or more media segments based on a plurality of viewpoints of the event, and a process of matching/selecting media segments based upon other user indicated criteria (e.g., timing, object characteristics, media segment/item characteristics, etc.). The communication module 207 may also be used in connection with the user interface client 109 to determine an input for selecting a subset of media items or media segments for presentation, when applicable, and/or causing a presentation and/or playback of the customized media item (e.g., a personalized video) on one or more displays.

In one embodiment, the media segment module 209 may be used to generate multiple personalized videos corresponding to multiple events. The media segment module 209, in connection with the editing module 211, may also be used to compile the one or more media segments generated by the segment module 209 and associate the one or more segments with respective personalized videos. By way of example, after the viewpoint module 205 segments a plurality of media items based on a focus and/or a plurality of viewpoints of an event (e.g., a violinist, a singer, etc.”), the editing module 211 may be used to compile the one or more media segments corresponding to each viewpoint. In addition, the editing module 211 may generate the videos with different synchronization criteria. Moreover, the editing module 211 may be used to generate a synchronization video between the personalized videos. For example, the editing module 211 may generate a customized media item (e.g. A personalized video) by combining multiple personalized videos in one video stream as a synchronized presentation.

The editing module 211 is used to synchronize matched/selected media segments into a personalized video. By way of example, the editing module 211 may determine the first frame of a media segment based on either the timing information associated with the media segment and/or, when applicable, the audio information associated with the media segment. In one embodiment, the editing module 211 may be used to automatically edit the one or more media segments associated with a viewpoint (e.g., the violinist viewed from the left front section) based on one or more parameters contained within the parameter database 117. By way of example, in the case of a music event, the editing module 211 can edit the one or more media segments based on beats per minute (bpm) of the audio portion of the media segment, quality of one or more media segments, quality of the audio portion of the one or more media segments, one or more significant events within the media segments, the duration of the media segments, and so forth. In one embodiment, the editing module 211 may be used to exchange one or more media segments for a viewpoint if the one or more segments fail to meet a threshold value associated with one or more parameters.

In one embodiment, the editing module 211 may be used to replace one or more media segments within a personalized video based on the number of display screens.

FIG. 2B is a diagram of the components of the user interface client 109, according to one example embodiment of the invention. By way of example, the user interface client 109 includes one or more client side components for providing generation of personalized video. It is contemplated that the functions of these components may be combined in one or more components or performed by other components of equivalent functionality. In this embodiment, the user interface client 109 includes a control logic 231, a communication module 233, and a user interface (UI) module 235.

Similar to the control module 201 of the media platform 103, the control logic 231 oversees the tasks, including tasks performed by the communication module 233, and the user interface (UI) module 235. For example, although the other modules may perform the actual task, the control logic 231 may determine when and how these tasks are preformed or otherwise direct the other modules to perform the task.

Similar to the communication module 207 of the media platform 103, the communication module 233 is used for communication between the media platform 103 and the user interface client 109 of the UEs 101. The communication module 233 may be used to communicate commands, requests, data, etc. More specifically, the communication module 233 is used for communication between the communication module 207 of the media platform 103 and the user interface module 235.

The user interface (UI) module 235 interacts with the media platform 103 in a client-server relationship to cause a rendering of a user interface for presenting the customized media item (e.g., a personalized video). More specifically, in one embodiment, the user interface module 235 may be used to render a user interface that includes one or more selectable user interface elements representing respective viewpoints (e.g., a violinist, a singer, etc.) and respective orientation information associated with each viewpoint (e.g., from the left from section, along a camera movement flow, etc.). By way of example, the user interface module 235 may be used to enable the user to select or determine which one or more viewpoints to compile one or more personalized videos, and to present and/or playback the one or more personalized videos in which format and/or order. In one embodiment, the user interface module renders the user interface elements relative to the videos as well as information of the orientation, the objects, the object characteristics, the media segment/item characteristics, or a combination thereof associated with the videos. The characteristics associated with the media segments/items, may include sudden changes of sound/lighting volumes (e.g., climax of the music, audience clapping, etc.), time of day, season, orientation, depth of field, white balance, author(s), etc. By way of example, the number, position, and size of the viewpoints may be presented as they change during the presentation of the customized media item due to the changes of the focus points and/orientations of the captured media items. An illustrative example of a two-dimensional user interface rendered by the user interface module 235 is shown in FIGS. 4A and 4C.

In another example embodiment, when the user interface module 235 determines that the display screen associated with the UEs 101 consists of a three-dimensional display, the user interface module 235 may be used to enable a user to orient and/or move a user interface in three-dimensions to view different media items, media segments, personalized videos, or a combination thereof. By way of example, the user interface module 235 may be used to render a user interface consisting of a cube for a personalized video consisting of six viewpoints, or an object determined by a user. In this example, a user can use a gesture relative to the cube interface to cause the user interface module 235 to rotate the UI and/or select one or more corresponding viewpoints to render. In another example embodiment, if the focus (sub-event) is three dimensional also relative height of viewpoints can be considered to create three-dimensional viewpoints that can be presented, for example, as cubes or blocks in a three-dimensional UI presentation.

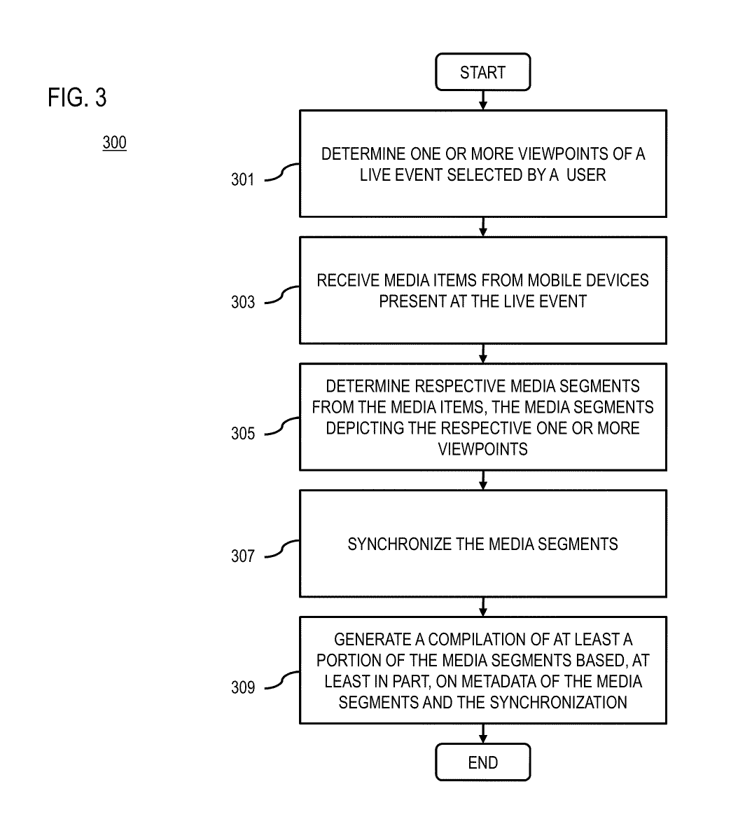

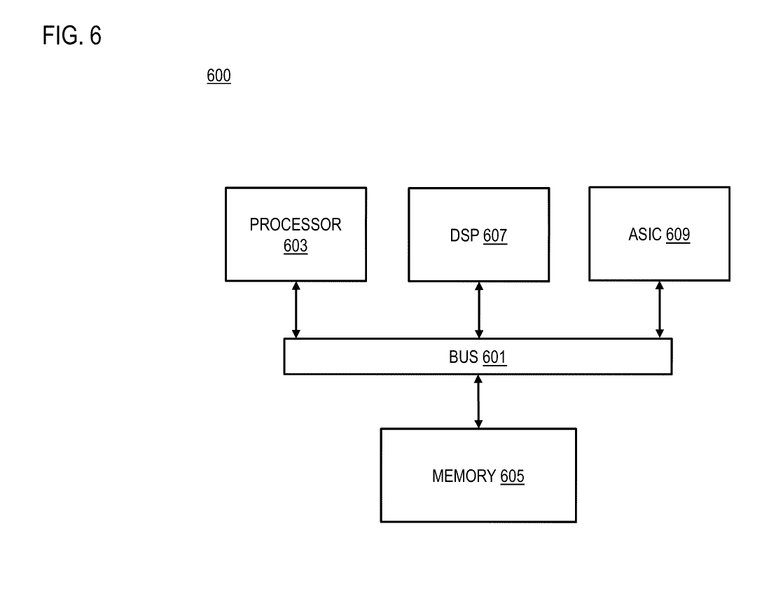

FIG. 3 is a flowchart of a process for user directed video editing, according to one embodiment. In one embodiment, the media platform 103 performs the process 300 and is implemented in, for instance, a chip set including a processor and a memory as shown in FIG. 6. In step 301, the media platform 103 determines one or more viewpoints of a live event selected by a remote user, based on one or more ordinal directions and distances between each source-target pair.

The one or more ordinal directions include, at least in part, left, right, up, down, front, back, or a combination thereof. In one embodiment, in addition to user interface entries, the media platform 103 may determine the plurality of viewpoints based on audio analysis of the user's voice commands.

In one embodiment, the media platform 103 retrieves a segmented map of the event venue. The segments pertain to sections of the map that have been demarcated based on criteria such as user positions, stage positions, left and right sides of stages, front and back views of arenas, side views, etc. In one embodiment, when the media platform 103 receives the media items along with metadata, the media platform 103 first maps the onsite users to segments of the map. This would also result in grouping the users on spatial grounds to match with user selected positions/coordinates. The media platform 103 then searches through the media segments captured by the users at the sources positions/coordinates for those with matched orientation towards the selected target positions/coordinates. In another embodiment, media platform 103 matches the source and target positions/coordinates concurrently.

By way of example, a user sitting remotely at home or work place logs in to the media platform 103 and selects a venue from the list of possible venues where events are happening. This results in download of the multi-segment-selectable map on to the remote user's device which can be a touch screen smart phone or PC. When the event starts or when live feeds start coming to the media platform 103, the media platform 103 can either randomly choose a first feed or start with a user submitted or selected viewpoint. The user submits the viewpoint by specifying a source and a target on the map. The source and target may be clickable (or selectable) by segments of the map. By way of example, the remote user selects a back row seat as source and a violinist on the left stage as target. The media platform 103 thus determines that the remote user wants live feed of media items taken by an onsite user in the back row and pointing in the specified stage direction. When the user simultaneously selects a source and a target through two touch points while either the touch points can logically form the source and the target, or vice versa, ambiguities arise. In this case, the system would indicate to the user, the system-perceived source and target via an arrow or other indication for the user to confirm. The user can either confirm or change the source and target (e.g., by changing the arrow direction).

In another embodiment, the remote user enters a plurality of source-target pairs with time duration to generate a personalized cut. The cut is fed live to the remote user's device. The selections made by the remote user on the device are recorded with directions data, duration for each direction, etc. along with any fading effects if chosen by the user.

In another embodiment, the remote user uses predetermined rules provided by a third party (e.g., other users, other service providers, etc.) for determining one or more source-target pairs.

In another embodiment, the media platform 103 analyzes the metadata associated with the media items (e.g., focus analysis based on the position of the UEs 101, altitude of the UEs 101, tilt of the UEs 101, orientation/angle of the UEs 101, zoom level of the camera lens of the UEs 101, focal length of the camera lens of the UEs 101, field of view of the camera lens of the UEs 101, radius of interest of the UEs 101 and/or range of interest, or a combination thereof) associated with the event. In other words, the media platform 103 determines from a majority of media items (e.g., onsite captured videos) which region or viewpoint of the event the majority of users were focused on (i.e., the signer's dance movement toward the audience). In addition to visual clues, the media platform 103 may determine the focus based on audio analysis. The media platform 103 then determines one or more viewpoints of the event based on the focus.

In step 303, the media platform 103 receives media items from a plurality of mobile devices present at the live event. By way of example, users are present in a concert hall. Some or all of the users may have registered to a social network platform, a media sharing platform, the media platform 103, or a combination thereof. Before recording and uploading (e.g., via a stream/feed or file transfer) the media items to the media platform 103 (or with some negligible post process delay), they are authenticated by the media platform 103. Metadata is uploaded along with the media items. The metadata includes user (client device) location information, device orientation information, accelerometer information, tilt and altitude information, etc. In one embodiment, the client software on the user devices for recording the media items may submit low resolution video for live services to accommodate bandwidth and processing restrictions. For example, the media items can be streamed to the media platform 103 and/or sent as a file, e.g., in Moving Picture Experts Group (MPEG) format, Windows® media formats (e.g., Windows® Media Video (WMV)), Audio Video Interleave (AVI) format, as well as new and/or proprietary formats.

In another embodiment, the media platform 103 causes, at least in part, a segmentation of a plurality of media items into the one or more media segments based, at least in part, on a plurality of viewpoints of at least one event. In one embodiment, the plurality of media items is determined by the media platform 103 from individual users recording and/or capturing media (e.g., video, audio, images, etc.) at an event (e.g., a concert) using their one or more personal recording devices (e.g., a mobile phone, a camcorder, a digital camera, etc.) and uploading the plurality of media items with respective context data (such as metadata) to one or more services that are capable of processing and/or storing the plurality of media items. In one embodiment, the media platform 103 segments the plurality of media items based, at least in part, on the viewpoint towards an object (e.g., a violinist, a singer, etc.) that the one or more segments within the plurality of media item (e.g., a video captured by an onsite user) refers to, which the media platform 103 determines from the plurality of media items, context data (e.g., metadata) associated with the plurality of media items, or a combination thereof.

In step 305, the media platform 103 determines respective media segments from the media items, the media segments depicting the respective one or more viewpoints. The media segments include metadata of orientation information, geo-location information, timing information, or a combination thereof associated with the creation of respective media segments. The orientation information includes accelerometer data, magnetometer data, altimeter data, zoom level data, focal length data, field of view data, range sensor data, or a combination thereof. In one embodiment, the media platform 103 causes, at least in part, a rendering of a user interface for determining a selection of the one or more viewpoints. The media platform 103 causes, at least in part, a rendering of the user interface based, at least in part, on the plurality of media segments associated with the one or more viewpoints. The media platform 103 causes, at least in part, a rendering of the user interface based, at least in part, on the ability to multiplex the plurality of media segments.

In step 307, the media platform 103 causes, at least in part, a synchronization of the media segments. The synchronization is based, at least in part, on the timing information, sensor information, media quality information, one or more audio cues, one or more visual cues, or a combination thereof associated with the plurality of media items, the media segments, the live event, or a combination thereof.

In one embodiment, the criterion used by the media platform 103 to synchronize the videos is based, at least in part, on the type of event captured by the onsite users. For example, in the case of a musical event (e.g., a concert), the media platform 103 may determine to synchronize one or more media segments based on timing information, audio clues, and/or visual clues associated with each media segment, so that audio/soundtrack is seamless even when the audio/soundtrack is played from the selected media segments. More specifically, the media platform 103 may determine not to playback and/or present the media segments representing the left side of the stage until the media platform 103 determines from the media segments that there is some noteworthy activity occurring with respect to the viewpoint. In other words, a display screen on the left side might remain blank at first and then come up as the activity on the stage involves the left side of the stage.

In another embodiment, the media platform 103 synchronizes the personalized videos within the compilation of the customized media item (e.g., personalized video) so that when the one or more personalized videos are presented and/or played back (e.g., each on a different screen) the media platform 103 is able to present to the remote user a desired representation of the event. In one embodiment, each personalized video created by the media platform 103 can have its own synchronization criterion, but in most cases, the videos begin and end at the same time.

The synchronization criteria, one or more synchronization start times, one or more synchronization end times, or a combination thereof are different for respective personalized videos. As previously discussed, the media platform 103 may generate each personalized video based on a different synchronization criterion, but in most cases the media platform 103 will start and end the personalized videos at the same time. It is contemplated that synchronizing the personalized videos in this manner will often enable the media platform 103 to present and/or display the customized media items (e.g., personalized videos) in manner most faithful to the actual event. In the example just mentioned, however, the media platform 103 may determine not to synchronize the start of two or more personalized videos based on the fact that a personalized video associated with a viewpoint contains an absence of activity. In another example, a user may determine to stagger the synchronization of personalized videos for dramatic effect.

In step 309, the media platform 103 determines to generate a compilation of at least a portion of the media segments based, at least in part, on the metadata (such as time/date, location, name of event, etc.) and the synchronization. The compilation is dynamically generated during the live event, playback of one or more of the media items, or a combination thereof. The media platform 103 causes, at least in part, a generation of a video for respective one or more viewpoints, wherein the video compiles one or more media segments that depict the respective one or more viewpoints. In one embodiment, the media platform 103 generates a video for each object of interest, a violinist, a singer, etc. In another embodiment, the media platform 103 compresses and/or compiles the multiple personalized videos into a single media stream.

In one embodiment, the media platform 103 determines one or more editing parameters for compiling the one or more media segments in the videos based, at least in part, on one or more characteristics of (a) the at least one event, (b) the plurality of media items, (c) the one or more media segments, or (d) a combination thereof. By way of example, as previously discussed, the media platform 103 determines a first frame for each media segment which can be based on either the timing information associated with the media segment or on a synchronization of the audio associated with the media segment depending on the event. In one embodiment, once the media platform 103 determines the first frame for each media segment, the media platform 103 then automatically edits the one or more media segments for each viewpoint based on one or more defined parameters. More specifically, the editing parameters are determined by the media platform 103 based on one or more characteristics related to the event, the media, the one or more media segments, or a combination thereof.

By way of example, in the case of a music event (e.g., a concert) the parameters determined by the media platform 103 may include beats per minute (bpm) of an audio portion of the one or more media segments, quality of the one or more segments available, quality of the audio channels associated with the one or more media segments, significant events happening within a particular viewpoint (e.g., viewing the violinist from the left front section), length of the one or more media segments, and so forth. In one embodiment, the media platform 103 can determine to substitute one or more media segments within a media channel with one or more media segments from a different user if the one or more media segments fall outside a threshold value associated with the one or more parameters. In another embodiment, the media platform 103 determines one or more transmission criteria, one or more user preferences, or a combination thereof for selecting from among the media segments. The compilation is further based, at least in part, on the selection. The transmission criteria include transmission quality, one or more bandwidth requirements, one or more resource restrictions, or a combination thereof. The one or more user preferences include one or more objects, one or more object characteristics, one or more media segment parameters, or a combination thereof, preferred by the user or one or more user groups. By way of examples, the object may be a pop singer, a basketball player, a ballet dancer, and the object characteristics may be user rating, book/movie reviews, top 100 playlists, etc.

Once the media platform 103 compiles media segments into one or more personalized videos, the media platform 103 may then present and/or playback each of the videos on a different display screen and/or present and/or playback the videos on a single display screen. In either instance, the media platform 103 is able to generate a desired and/or seamless video representation of the event.

In another embodiment, when the display screen and/or user interface (UI) for the customized media item consists of a three-dimensional display, the media platform 103 may be used to enable a user to orient and/or move the UI in three-dimensions to view one or more media channels. By way of example, the media platform 103 may be used to render a user interface consisting of a cube for a customized media item consisting of six viewpoints, or an object determined by a user based on the same concept of associating one or more user interface elements with one or more viewpoints. In this example, a user can use a gesture referencing the cube interface to cause the media platform 103 to rotate the UI and/or select one or more corresponding media segments to render.

In one embodiment, the media platform 103 causes, at least in part, a rendering of a user interface, wherein the user interface is presented on a device with multiple display capabilities including, at least in part, one or more display screens, one or more projectors, or a combination thereof. By way of example, the media platform 103 may be used to render a user interface for presenting the customized media item (e.g., a personalized video) on a mobile device (e.g., a pico projector). In one example the mobile device may be equipped with multiple projecting lenses or pico projectors (e.g., three lenses corresponding to personalized videos). The advantage of multiple display screens is that each personalized video can be presented and/or played back separately and simultaneously on a different display screen creating a desired and/or seamless experience for the user.

In another embodiment, the media platform 103 determines to provide the compilation, the media items, the media segments, or a combination thereof on a web portal.

In yet another embodiment, the media platform 103 makes high resolution cuts through post-creation, by fetching of higher quality video and audio.

The client software on the remote user device can store either the personalized cuts or just the metadata related to creating the personalized cuts. The remote user can regenerate the personalized cuts locally or by submitting the metadata related to the personalized cuts (such as target and source, duration for each segment, fading effects, etc.) to the media platform 103 for the same cuts or better quality cuts. Here, the media platform 103 can use higher resolution videos and better audio, etc. than what were used when feeding the live event. The user can also share their personalized cuts by uploading either the personalized cuts or the metadata related to the personalized cuts to social media platforms.

FIGS. 4A-4C are diagrams of a user interface utilized in the process of FIG. 3, according to various example embodiments. As shown, the example user interface of FIG. 4A includes one or more user interface elements, such as the viewpoints, and/or functionalities created and/or modified based, at least in part, on information, data, and/or signals resulting from the process 300 described with respect to FIG. 3. More specifically, FIG. 4A illustrates a user interface (e.g., interface 401) for presenting a customized media item (e.g., personalized video) of an event (e.g., a concert) on a single two-dimensional screen. As previously discussed, the interface 401 is generated by the media platform 103 based on the viewpoints selected by a remote user and the context information associated with the one or more media segments determined from a plurality of media items captured during the event. As shown in FIG. 4A, a user is able to touch or select a source position 403 and one or more target positions on the stage (e.g., a violinist 405, a singer 407, etc.) to determine which respective viewpoints V and S is presented as arrows on one or more display screens. FIG. 4B shows on the top the violinist video includes viewpoints 421-431 of the violinist, a flutist, a cellist, a pianist, the singer, and the guitarist. FIG. 4B also shows the singer video from different viewpoints 433-443. In addition, a user has the option to present and/or playback the media items, media segments, personalized videos, or a combination thereof by touching an automatic mixing element 409 and or a change view element 411 in different manners. A user is able to touch or select the automatic mixing element 409 to concurrently present the violinist video and the singer video, and the change view element 411 to set the videos in a picture-in-picture mode. An interface 461 shown in FIG. 4C has the singer video shown in a main screen 463 and the violinist video shown in a secondary screen 465.

In some example embodiments, the user interface can be three-dimensional, wherein the viewpoints can be presented as cubes or blocks and the whole user interface with its elements can be rotated over the three axis. In some example embodiments, the two-dimensional user interface can be overlaid on a map presentation.

The example embodiments allow a user to actually direct a customized video/cut, including in a live scenario, by single and multi-touch on a map to indicate viewpoints. Therefore, remote users who are not actual participants in a live event can not only view different views of the live event but also easily and efficiently create their own videos, and share those editing metadata or videos through a media platform.

The processes described herein for remote user directed video editing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

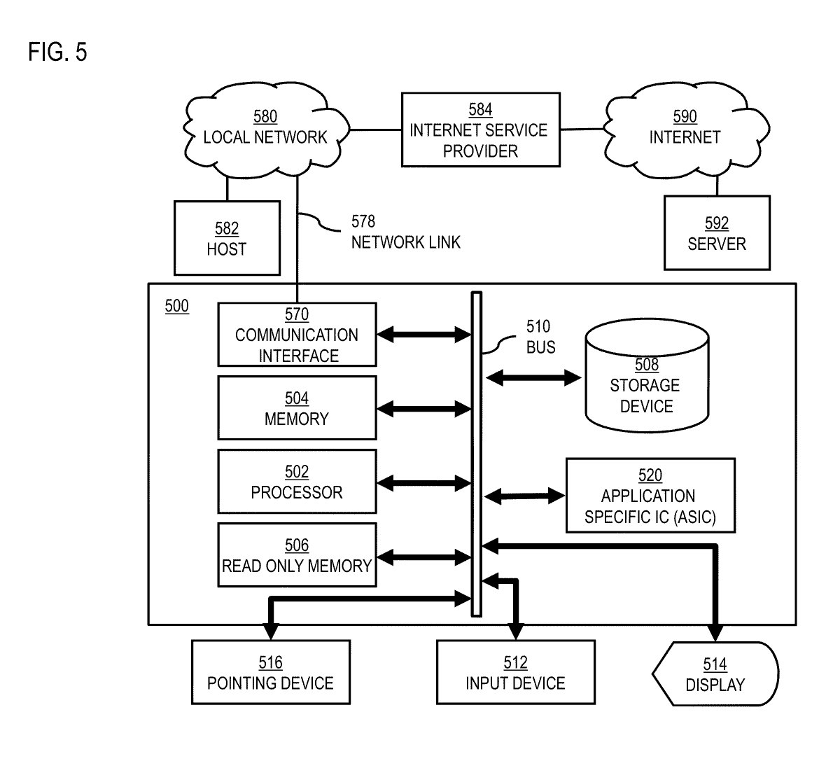

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to support user directed video editing as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of supporting user directed video editing.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to support user directed video editing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for supporting user directed video editing. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for supporting user directed video editing, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection between the UE 101 and the communication network 105 for supporting user directed video editing.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to support user directed video editing as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of supporting user directed video editing.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to support user directed video editing. The memory 605 also stores the data associated with or generated by the execution of the inventive steps.

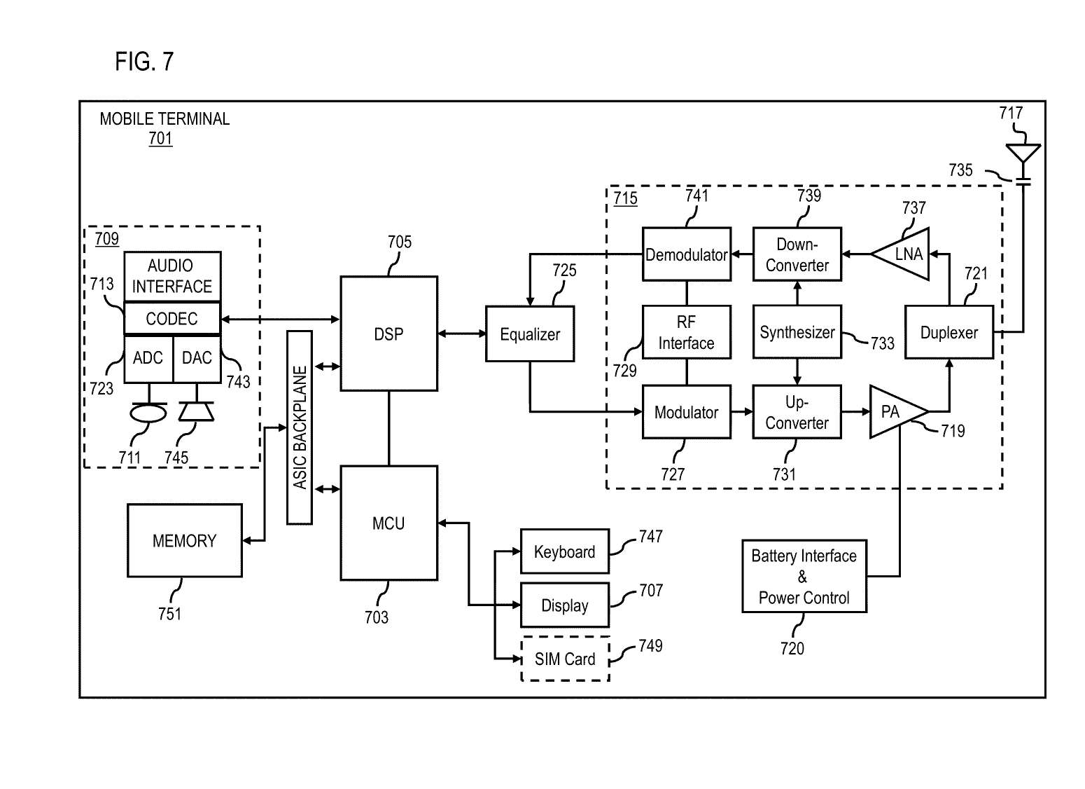

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of supporting user directed video editing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of supporting user directed video editing. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 is a user interface software to facilitate user control of at least some functions of the mobile terminal 701 to support user directed video editing. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more viewpoints of a live event selected by a remote user;
at least one determination of media items from a plurality of mobile devices present at the live event;
at least one determination from the media items respective media segments that depict the respective one or more viewpoints, wherein the media segments include metadata of orientation information, geo-location information, timing information, or a combination thereof associated with the creation of respective media segments;
at least one synchronization of the media segments; and
at least one determination to generate a compilation of at least a portion of the media segments based, at least in part, on the metadata and the synchronization,
wherein the synchronization is based, at least in part, on accelerometer information, media quality information, one or more audio cues, one or more visual cues, or a combination thereof associated with the plurality of media items, the media segments, the live event, or a combination thereof.

2. A method according to claim 1, wherein the (1) data and/or (2) information and/or (3) at least one signal are further based, at least in part, on the following:
at least one determination one or more transmission criteria, one or more user preferences, or a combination thereof for selecting from among the media segments,
wherein the compilation is further based, at least in part, on the selection.

3. A method according to claim 1, wherein the (1) data and/or (2) information and/or (3) at least one signal are further based, at least in part, on the following:
at least one determination of a focus of the live event by analyzing visual and/or audio overlap among the plurality of media items; and
at least one determination the media segments from the media items based upon the focus,
wherein the synchronization is based, at least in part, on the focus.

4. A method according to claim 3, wherein the (1) data and/or (2) information and/or (3) at least one signal are further based, at least in part, on the following:
at least one quality determination of the one or more media segments by using the accelerometer information,
wherein the synchronization is based, at least in part, on the quality determination.

5. A method according to claim 1, wherein the (1) data and/or (2) information and/or (3) at least one signal are further based, at least in part, on the following:
at least one generation of a synchronization video between the personalized videos; and
at least one determination to provide the compilation, the media items, the media segments, or a combination thereof on a web portal.

6. A method according to claim 1, wherein the synchronization is based, at least in part, on the timing information, the orientation, location information, or a combination thereof associated with the plurality of media items, the media segments, the live event, or a combination thereof.

7. A method according to claim 1, wherein the (1) data and/or (2) information and/or (3) at least one signal are further based, at least in part, on the following:
a rendering of a user interface for determining a selection of the one or more viewpoints;
a rendering of the user interface based, at least in part, on the plurality of media segments associated with the one or more viewpoints;
at least one determination not to synchronize a start of two or more personalized videos based on a fact that one of the personalized videos contains an absence of activity; and
a rendering of the user interface based, at least in part, on the ability to multiplex the plurality of media segments.

8. A method according to claim 1, wherein the compilation is dynamically generated during the live event, playback of one or more of the media items, or a combination thereof.

9. A method according to claim 1, wherein the orientation information includes accelerometer data, magnetometer data, altimeter data, zoom level data, focal length data, field of view data, range sensor data, or a combination thereof.

10. A method according to claim 2, wherein the (1) data and/or (2) information and/or (3) at least one signal are further based, at least in part, on the following:
at least one determination of substitution of one or more media segments within a media channel with one or more media segments from a different user device, when the one or more media segments fall outside a threshold value, wherein the threshold value is associated with one or more parameters that include a beats per minute of an audio portion of the one or more media segments, quality of the audio channels associated with the one or more media segments, one or more significant events happening within a predetermined viewpoint, or a combination thereof,
wherein the transmission criteria include transmission quality, one or more bandwidth requirements, one or more resource restrictions, or a combination thereof, and wherein the one or more user preferences include one or more objects, one or more object characteristics, one or more media segment parameters, or a combination thereof, preferred by the user or one or more user groups.

11. An apparatus comprising:
at least one processor; and
at least one memory including computer program code for one or more programs,
the at least one memory and the computer program code configured to, with the at least one processor, cause the apparatus to perform at least the following,
determining one or more viewpoints of a live event selected by a user;
determining media items from a plurality of mobile devices present at the live event;
determining from the media items respective media segments that depict the respective one or more viewpoints, wherein the media segments include metadata of orientation information, geo-location information, timing information, or a combination thereof associated with the creation of respective media segments;
determining to synchronize the media segments; and
determining to generate a compilation of at least a portion of the media segments based, at least in part, on the metadata and the synchronization,
wherein the synchronization is based, at least in part, on accelerometer information, media quality information, one or more audio cues, one or more visual cues, or a combination thereof associated with the plurality of media items, the media segments, the live event, or a combination thereof.

12. An apparatus according to claim 11, wherein the apparatus is further caused to:
determining one or more transmission criteria, one or more user preferences, or a combination thereof for selecting from among the media segments,
wherein the compilation is further based, at least in part, on the selection.

13. An apparatus according to claim 12, wherein the apparatus is further caused to:
receiving media items from a plurality of mobile devices present at the live event; and
determining the media segments from the media items.

14. An apparatus according to claim 13, wherein the apparatus is further caused to:
causing, at least in part, a synchronization of the media segments,
wherein the compilation of the media segments is based, at least in part, on the synchronization.

15. An apparatus according to claim 14, wherein the apparatus is further caused to:
determining to provide the compilation, the media items, the media segments, or a combination thereof on a web portal.

16. An apparatus according to claim 14, wherein the synchronization is based, at least in part, on the timing information, sensor information, media quality information, one or more audio cues, one or more visual cues, or a combination thereof associated with the plurality of media items, the media segments, the live event, or a combination thereof.

17. An apparatus according to claim 13, wherein the apparatus is further caused to:
causing, at least in part, a rendering of a user interface for determining a selection of the one or more viewpoints;
causing, at least in part, a rendering of the user interface based, at least in part, on the plurality of media segments associated with the one or more viewpoints; and
causing, at least in part, a rendering of the user interface based, at least in part, on the ability to multiplex the plurality of media segments.

18. An apparatus according to claim 11, wherein the compilation is dynamically generated during the live event, playback of one or more of the media items, or a combination thereof.

19. An apparatus according to claim 11, wherein the orientation information includes accelerometer data, magnetometer data, altimeter data, zoom level data, focal length data, field of view data, range sensor data, or a combination thereof.

20. An apparatus according to claim 12, wherein the transmission criteria include transmission quality, one or more bandwidth requirements, one or more resource restrictions, or a combination thereof, and wherein the one or more user preferences include one or more objects, one or more object characteristics, one or more media segment parameters, or a combination thereof, preferred by the user or one or more user groups.

21-48. (canceled)
